(19) United States
(12) Patent Application Publication
(10) Pub. No.: US 2009/0134166 A1
(43) Pub. Date: May 28, 2009

(54) Additive tank for fuel system and production method thereof

(75) Inventors: Thierry Campenon, Laval (FR); Olivier Kunstmann, Argentre (FR)

Correspondence Address: CONNOLLY BOVE LODGE & HUTZ, LLP, P O BOX 2207, WILMINGTON, DE, 19899, US

(73) Assignee: Inergy Automotive Systems Research, Brussels (BE)

(21) Appl. No.: 10/554,985

(22) PCT Filed: Apr. 29, 2004
(86) PCT No.: PCT/EP04/50654

§ 371 Date: Jul. 3, 2006

(30) Foreign Application Priority Data
Apr. 30, 2003 (FR) 03/05436
Nov. 7, 2003 (FR) 03/13073

(51) Int. Cl. B65D 51/16; B29C 49/06

(52) U.S. Cl. 220/367.1; 264/513

(57) ABSTRACT

Additive reservoir for a fuel system, comprising a closed plastic enclosure associated with a main fuel tank filling tube.

Two-step process for manufacturing such a reservoir, in which firstly a closed plastic enclosure is faintly and then the enclosure is assembled or connected onto a main fuel tank filling tube.

The present invention relates to an additive reservoir for a fuel system.

The desire for increased environmental protection has lead national and international authorities of many regions of the world to make regulatory constraints more stringent in many fields, in particular in the field of motor vehicle transport. In the case of vehicles driven by a diesel-consuming internal combustion engine, recent standards greatly limit the permissible amount of solid particulates discharged into the atmosphere. Automobile manufacturers of vehicles propelled by compression-ignition engines have provided a solution to this problem by equipping these vehicles with particulate filters placed in the exhaust pipe for discharging the combustion gases into the atmosphere. To regenerate the filtering capability of these particulate filters, the particulates partially clogging the filters have to be burnt off at regular intervals.

To be able to automate the periodic cycle of particulate filter regeneration, it has been necessary to find a means of lowering the combustion temperature of these particulates so that it is compatible with the highest temperatures that can be obtained in the exhaust gases by a suitable and temporary adjustment of the combustion parameters of the engine itself. It has been recognized that it is necessary to use a certain quantity of chemical combustion additive so that the lowering of the combustion temperature of the solid particulates can take place in the exhaust gases at a temperature level that is compatible with the engine combustion and with complete elimination of the particulates.

Liquid additive reservoirs, small in volume compared with the fuel tank, have been designed so as to be mounted on or near the fuel tank of diesel-engine vehicles. Such additive reservoirs require the fitting of a suitable complex interface for communication with the filet tan It is often only with difficulty that this interface can meet the vibration resistance, crush resistance and fire resistance criteria required by the various statutory regulations in force.

Moreover, the maximum amount of liquid additive contained in the additive reservoir does not in general meet the needs for catalyzing the combustion of particulates emitted over the lifetime of a vehicle. It is therefore generally necessary to fill the additive reservoir several times, this usually being carried out when the vehicle is being serviced by a professional mechanic. These filling operations often pose the additional problems of cleanliness and ergonomics, and there is also the problem of whether the reservoir has been reliably filled with the correct volume of additive.

It is an object of the invention to provide an additive reservoir for a fuel system that reduces or eliminates the problems associated with the current additive reservoir architectures, especially ergonomic, cleanliness and filling reliability problems.

For this purpose, the subject of the invention is an additive reservoir for a fuel system comprising a sealed plastic enclosure, whereby the additive reservoir is associated with a tube for filling a main fuel tank.

The term “additive reservoir” is understood to mean a reservoir capable of storing and delivering a liquid additive for fuel in a stationary or on-board system, in particular on board a motor vehicle. The term “motor vehicle” is understood to mean cars, lorries and motorcycles.

The additive contained in the reservoir is a composition, dissolved in a hydrocarbon solvent, of a catalyst for the low-temperature combustion of solid carbon particulates produced by the incomplete combustion of a heavy hydrocarbon in a compression-ignition engine. The term “heavy hydrocarbon” is understood to mean a fuel that is liquid or pasty at ordinary temperature, the molecules of which contain more than 9 carbon atoms. An example of such a heavy hydrocarbon is the oil fraction called gasoil or diesel, which can be used in diesel engines.

Examples of liquid additives that are suitable are iron and cerium salts in a hydrocarbon solution.

According to the invention, the additive reservoir is intended for a fuel system, that is to say any device incorporated into a vehicle or into a fixed installation, the main function of which is to store, purify, measure or transport a fuel for supplying an internal combustion engine. It comprises at least a fuel tank and a line for supplying the engine with fuel.

According to the invention, the additive reservoir is a sealed enclosure. The term “sealed enclosure” is understood to mean a hollow body, of various shapes, generally sealed with respect to the outside and able to be equipped with various internal or external accessories or else accessories that pass through the wall of the enclosure, such as valves, delivery tubes, liquid/vapour separators and venting chambers.

According to the invention, the additive reservoir is made of a plastic. The term “plastic” is understood to mean any material comprising at least one synthetic resin polymer.

All types of plastic may be suitable. Very suitable plastics fall within the category of thermoplastics.

The term “thermoplastic” is understood to mean any thermoplastic polymer, including thermoplastic elastomers, and blends thereof. The term “polymer” is understood to mean both homopolymers and copolymers (especially binary or ternary copolymers). Examples of such copolymers are, non-limitingly: random copolymers, linear block copolymers, other block copolymers and grafted copolymers.

Any type of thermoplastic polymer or copolymer, the melting point of which is below the decomposition temperature, is suitable. Thermoplastics having a melting range spread over at least 10 degrees Celsius are particularly suitable. Examples of such materials include those exhibiting a polydispersion in their molecular weight.

In particular, it is possible to use polyolefins, polyvinyl halides, thermoplastic polyesters, polyketones, polyamides and copolymers thereof. A polymer or copolymer blend may also be used, and also a blend of polymeric materials with inorganic, organic and/or natural fillers such as, for example, but not limitingly: carbon, salts and other inorganic derivatives, natural fibres, glass fibres and polymer fibres. It is also possible to use multilayer structures consisting of stacked layers bonded together, comprising at least one of the abovementioned polymers or copolymers.

Polyvinyl halides and polyolefins are generally preferred.

A polymer often employed is polyethylene. Excellent results have been obtained with high-density polyethylene (HDPE).

According to the invention, the additive reservoir is associated with a tube for filling the fuel tank. The fuel tank filling tube is generally a single-layer or multilayer plastic pipe that connects the fuel tank to a point located usually at a higher level than the tank, via which pipe the tank can be refuelled. The word “associated” is understood to mean “fastened to” or “connected to via one or more lines”.

The fastening may be carried out by at least one mechanical securing means for joining the additive reservoir to the fuel tank filling tube. Examples of such securing means are, non-limitingly: welding, bolting, strapping, bonding, clip-fastening and clamping. Welding and clamping have given good results. If the additive reservoir is fastened to the filling tube, it is generally located away from the volume of the main fuel tank that is to say it constitutes a reservoir separate from the fuel tank to which it is connected only via one or more lines.

The connection via one or more lines is such that the additive reservoir can be filled via the main fuel tank filler head.

According to a first embodiment of the invention, the additive reservoir may replace a venting chamber mounted on the top of the main fuel tank filling tube. Such a chamber is frequently found in fuel systems and can be fitted onto the top of a filling tube. Its purpose is in general to separate, retain and return, to the fuel tank, any liquid fuel entrainment escaping with the gases when filling the fuel tank. In this embodiment, the venting chamber is displaced to another point near the fuel tank. It may also be omitted and its function provided by the addition on the tank of a special valve that carries out the same function of trapping any liquid fuel entrainment in the gas flow escaping from the fuel tank.

In a second embodiment of the additive reservoir according to the invention, this reservoir may be placed alongside a venting chamber mounted on the top of the main fuel tank filling tube. In general, in this embodiment, the means for securing the chamber to the tube are similar to those for the additive reservoir and the tube. Further means of securing the additive reservoir to the venting chamber may also be added for the purpose of strengthening the tube/additive reservoir/venting chamber assembly.

In a third embodiment of the additive reservoir according to the invention, this reservoir may be placed in any part of the vehicle (for example in or on the main fuel tank), but it is connected on the one band to the filler head via at least one line whose shape and size are matched to the geometry of the environment and to the desired flow rate, and on the other hand, to the main fuel tank via another line.

In the abovementioned three embodiments of the additive reservoir, there may advantageously be an additive filling line and a venting line for this additive reservoir, both these lines terminating in a device with which the top of the main fuel tank filling tube is equipped, alongside the guiding orifice for a fuel delivery nozzle. A common plug on the ends of these two lines may also ensure that they are relatively well sealed outside the periods when this additive reservoir is being filled.

In this advantageous embodiment of the additive reservoir according to the invention, the venting line of the additive reservoir may be provided, in its top part, with means for visually indicating to an operator that there is an over-fill state at the end of a procedure to top up with additive via the filling line. These means may consist, for example, of a float placed in the venting line, which float rises up to the upper orifice of this line, whenever the reservoir is filled with additive and runs the risk of spilling out of this line.

Furthermore, if the additive reservoir can be seen by the user (that is to say the person filling it), the said reservoir may be transparent or translucent and/or include a level bar system.

In one or other of the various embodiments of the additive reservoir described above, the latter may advantageously be associated with a metering device, an outlet of which communicates with the main fuel tank. Such a device may consist of various metering systems, well known per se. Examples of such systems are, non-limitingly: a solenoid valve, the opening and closing of which are controlled by the engine management computer of the vehicle inserted into a pipe leaving the bottom of the tank and allowing the natural flow under gravity of a certain amount of additive to be metered; or a metering pump, actuated by an electric motor controlled by the same computer, which outputs a flow of additive into an injector located on one wall of the main tank. Preferably, the metering system consists of a syringe pump, such as that described in Application FR 0320880.8 in the name of the Applicant and the content of which is incorporated into the present application by reference.

The metering system may either be located directly on the additive reservoir, preferably in its lower part, or it may be fastened to an accessory support plate fastened to the reservoir, or else to any other element of the fuel system intended to supply the engine with the said fuel, and to do so by clip-fastening, welding or bonding the body. For example, this fastening operation may be carried out beneath the volume of the filling tube, on the wall of the tube in a high position (near the top), on the wall of the reservoir or in the fuel-withdrawing module.

Finally, the additive reservoir according to the invention is preferably provided with at least two lines—one for filling and the other for venting—the latter being preferably provided with a pressure/underpressure safety system. The purpose of this system is in particular to extract the air present in the reservoir during filling pressure safety) and to replace the additive volume progressively consumed during operation of the vehicle with air (underpressure safety). Advantageously, this system comprises a valve that opens only above a given pressure threshold (for example greater than 120 mbar), so as to prevent any additive leakage and undesirable ingress of liquid, dust etc.

The invention also relates to a process for manufacturing an additive reservoir for a fuel system, made of plastic, in which, in a first step, a closed plastic enclosure is firstly moulded using a technique chosen from extrusion-blow moulding of a parison and the injection-welding of shells, and, in a second step, the enclosure is then assembled or connected onto a main fuel tank filling tube.

In this process, the terms used have the same meanings as those used earlier for describing the additive reservoir.

In one advantageous method of implementing the process according to the invention, which is preferred, the first step is carried out by injection-blow moulding of a parison that is also used to produce the main fuel tank filling tube at the same time as the additive reservoir, and the second step is carried out by letting the plastic join up, directly on leaving the mould and without requiring an additional means for fastening the additive reservoir to the main fuel tank filling tube. This results in a substantial reduction in the complexity and in the cost of the filling tube/additive reservoir assembly. Furthermore, the robustness and strength of the assembly are improved as a result, without the fire behaviour of the fuel system being affected thereby.

Alternatively, and within the same concept, the additive reservoir may be produced as a single part with any other part of a fuel system, for example with the wall of the main fuel tank.

An alternative method of implementing the process according to the invention consists, in the first step, in blow moulding a plastic parison in a separate mould so as to produce the additive reservoir and, in the second step, in assembling or connecting the reservoir produced in the first step onto the main fuel tank filling tube, as described above.

Finally, it is also possible, alternatively, to firstly injection mould, in a first step, two hollow plastic parts in an injection moulding mould so as to obtain two shells that are then welded together to form an additive reservoir and, in a second step, to assemble or connect the reservoir produced in the first step onto the main filer tank filling tube, as described above.

The figures below are given for the purpose of illustrating the invention, without however wishing thereby to restrict its scope.

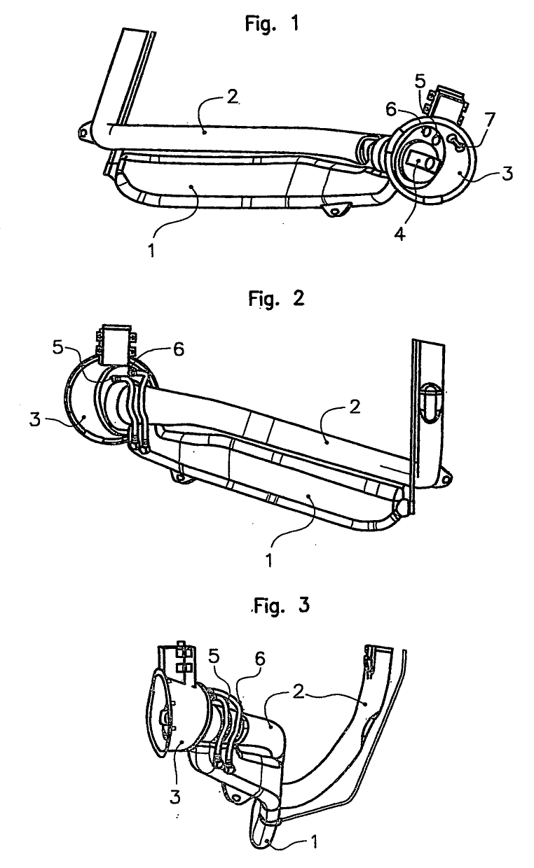

FIGS. 1 to 3 show a front view (FIG. 1), a rear view (FIG. 2) and a side view (FIG. 3) of a HDPE additive reservoir (1)/filling tube (2) assembly for a fuel system. A device (3) at the top of the tube (2) reveals a fuel tank cap (4) that closes off the orifice for guiding the delivery nozzle (not shown). Also distinguished are the filling line (5) and the venting line (6) for the additive reservoir (1), these emerging in the device (3) at the top of the tube. A double plug (7) can be seen in FIG. 1, removed so as to expose the openings of the lines (5) and (6).

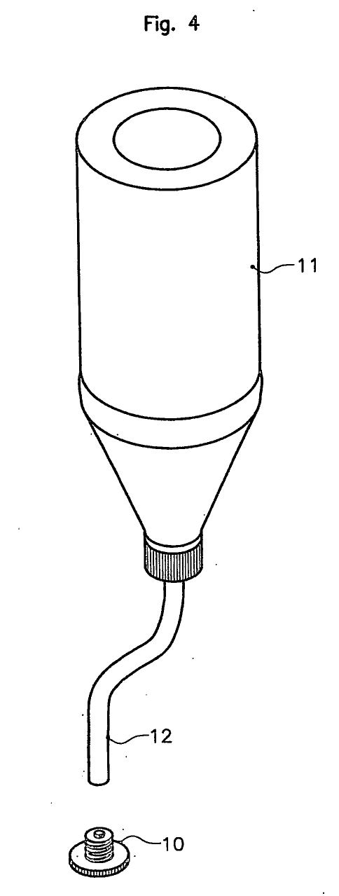

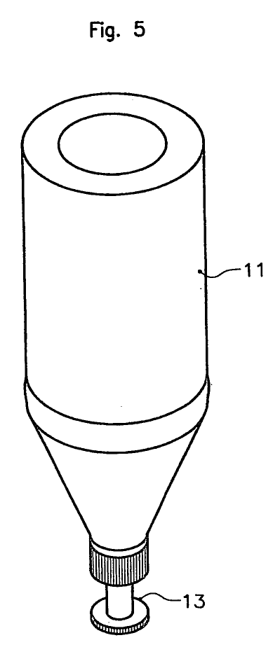

The diagrams in FIGS. 4 and 5 are of additive refill containers (11) that allow the additive reservoir according to the invention to be filled easily and cleanly. The containers (11) are made of a flexible plastic and they contain a correctly metered volume of liquid additive corresponding to the precise volume of the additive reservoir.

In FIG. 4, a coupler (10), designed to be screwed onto the top of the filling line (5) of the additive reservoir (1), allows a hose (12) to be connected, linked at its other end to the refill container (11).

In FIG. 5, a coupler (13), which is also screwed onto the top of the filling line (5) of the additive reservoir (1), is fastened directly to the top of the additive refill container (11). The mechanic responsible for servicing the vehicle can easily and cleanly transfer the additive contents of the refill container into the additive reservoir by simply pressing on the walls of the flexible refill container (11).

1. Additive reservoir for a fuel system, comprising a closed plastic enclosure, characterized in that the additive reservoir is associated with a tube for filling a main fuel tank.

2. Additive reservoir according to the preceding claim, characterized in that it replaces a venting chamber mounted on the top of the main fuel tank filling tube.

3. Additive reservoir according to claim 1, characterized in that it is placed alongside a venting chamber mounted on the top of the main fuel tank filling tube.

4. Additive reservoir according to any one of the preceding claims, characterized in that an additive filling line and a venting line of the additive reservoir terminate in a device with which the top of the main fuel tank filling tube is equipped, alongside a guiding orifice for a fuel delivery nozzle.

5. Reservoir according to the preceding claim, characterized in that the venting line of the additive reservoir is provided, in its top part, with means for visually indicating to an operator that there is an over-fill state at the end of an operation to top up with additive via the filling line.

6. Reservoir according to any one of the preceding claims, characterized in that the said reservoir is transparent or translucent and/or includes a level bar system.

7. Additive reservoir according to any one of the preceding claims, characterized in that it is provided with an additive metering device, an outlet of which communicates with the main fuel tank.

8. Additive reservoir according to any one of the preceding claims, characterized in that it is provided with a pressure/underpressure safety system.

9. Process for manufacturing an additive reservoir for a filet system, made of plastic, characterized in that, in a first step, a closed plastic enclosure is firstly moulded using a technique chosen from extrusion-blow moulding of a parison and the injection-welding of shells, and, in a second step, the enclosure is then assembled or connected onto a main fuel tank filling tube.

10. Process according to the preceding claim, characterized in that the first step is carried out by injection-blow moulding of a parison that is also used to produce the main fuel tank filling tube at the same time as the additive reservoir, and in that the second step is carried out by letting the plastic join up, directly on leaving the mould and without requiring an additional means for fastening the additive reservoir to the main fuel tank filling tube.

11. Process according to claim 9, characterized in that the additive reservoir is produced as a single part with the wall of the main fuel tank.

12. Process according to claim 9, characterized in that the first step consists in blow moulding a plastic parison in a separate mould so as to produce the additive reservoir and in that the second step consists in assembling the reservoir produced in the first step onto the main fuel tank filling tube using a technique chosen from welding and mechanical fastening, by means of a clip or a clamp.

13. Process according to claim 9, characterized in that the first step consists in firstly injection moulding two plastic hollow parts in an injection-moulding mould so as to obtain two shells that are then welded together to form an additive reservoir and in that the second step consists in assembling the reservoir produced in the first step onto the main fuel tank filling tube using a technique chosen from welding and mechanical fastening, by means of a clip or clamp.
